(19) United States
(12) Patent Application Publication
(10) Pub. No.: US 2007/0262707 A1
(43) Pub. Date: Nov. 15, 2007

(54) ORGANIC ELECTROLUMINESCENT DEVICE AND METHOD OF MANUFACTURING THE SAME

(75) Inventors: Young-gu LEE, Yongin-si (KR); Sung-kee KANG, Yongin-si (KR); Ho-nyeon LEE, Yongin-si (KR)

Correspondence Address: CANTOR COLBURN, LLP, 55 GRIFFIN ROAD SOUTH, BLOOMFIELD, CT, 06002, US

(73) Assignee: SAMSUNG ELECTRONICS CO., LTD., Suwon-si (KR)

(21) Appl. No.: 11/748,934

(22) Filed: May 15, 2007

(30) Foreign Application Priority Data
May 15, 2006 (KR) 10-2006-0043465

(51) Int. Cl. H01J 1/62; H01J 63/04

(52) U.S. Cl. 313/504

(57) ABSTRACT

An organic electroluminescent device and a method of manufacturing the same include a substrate, a plurality of first electrodes formed on the substrate, a plurality of banks formed on the substrate to define pixels on the first electrodes, a plurality of organic light emitting layers filled in the pixels, a second electrode formed of a metal on upper surfaces of the banks and the organic light emitting layers, and an auxiliary electrode formed of a metal in a predetermined shape on an upper surface of the second electrode disposed on the banks.

This application claims priority to Korean Patent Application No. 10-2006-0043465, filed on May 15, 2006, and all the benefits accruing therefrom under 35 U.S.C. §119, the contents of which in its entirety are herein incorporated by reference.

### BACKGROUND OF THE INVENTION

1. Field of the Invention

The present invention relates to an organic electroluminescent device and a method of manufacturing the same, and more particularly, to a top emission type organic electroluminescent device having an electrode which increases light transmittance and electrical conductivity and a method of manufacturing the same.

2. Description of the Related Art

An organic electroluminescent device is a display device which displays images using light emitted from an organic light emitting layer formed between an anode electrode and a cathode electrode. Light is emitted from the organic light emitting layer by a combination of holes, supplied from the anode electrode, and electrons, supplied from the cathode electrode. Due to its excellent display characteristics, such as a large viewing angle, high response speed, thin shape and high contrast, the organic electroluminescent device is expected to become one of the next generation flat panel display devices.

The organic electroluminescent device can be classified as either a passive matrix (“PM”) type or an active matrix (“AM”) type, according to a driving method thereof. The PM type organic electroluminescent device has a structure in which an anode electrode and a cathode electrode are arranged in a matrix. The AM type organic electroluminescent device has a structure in which each pixel includes an anode electrode, a plurality of thin film transistors (“TFTs”) and capacitors. In addition, the organic electroluminescent device can be classified as either a top emission type or a bottom emission type, according to the direction of light emitted from an organic emitting layer.

FIG. 1 shows a cross-sectional view of a top emission AM type organic electroluminescent device disclosed in U.S. Pat. No. 6,836,070. Referring to FIG. 1, anode electrodes 22 driven by a plurality of TFTs and banks 24 which define pixels are formed on a substrate 20. An organic light emitting layer 26 which emits a predetermined color is formed in each pixel, and a cathode electrode 28 is formed on the banks 24 and the organic light emitting layers 26. Protective layers 30, 32 and 34 formed of a transparent material are sequentially formed on the cathode electrode 28. In the above structure, if a predetermined voltage is respectively applied to the anode electrodes 22 and the cathode electrode 28, visible light is emitted from the organic light emitting layer 26 in a predetermined pixel, and the visible light is emitted to the outside through the cathode electrode 28 and the protective layers 30, 32 and 34.

In the above top emission type organic electroluminescent device, if the cathode electrode 28 is formed in a single metal layer or multiple metal layers, the thickness of the cathode electrode must be very thin in order to increase light transmittance therethrough. However, if the cathode electrode 28 is too thin, the electrical conductivity thereof may decrease. Also, when the metal is deposited to a thickness of a few tens of angstroms (Å), a tiny thickness difference can occur. Even though there is a tiny thickness difference, light transmittance varies greatly, thereby reducing the reproducibility of process. If the cathode electrode 28 is formed of a transparent conductive material such as indium tin oxide (“ITO”) or indium zinc oxide (“IZO”), the light transmittance of the cathode electrode 28 increases. However, a sputtering method is used to deposit a transparent conductive material such as ITO,. In this case, the organic light emitting layer 26 can be damaged in the sputtering process.

### BRIEF SUMMARY OF THE INVENTION

The present invention provides a top emission type organic electroluminescent device having an electrode which increases light transmittance and electrical conductivity and a method of manufacturing the same.

According to an aspect of the present invention, an exemplary embodiment of an organic electroluminescent device includes: a substrate; a plurality of first electrodes formed on the substrate; a plurality of banks formed on the substrate to define pixels on the first electrodes; a plurality of organic light emitting layers filled in the pixels; a second electrode formed of a metal on upper surfaces of the banks and the organic light emitting layers; and an auxiliary electrode formed of a metal in a predetermined shape on an upper surface of the second electrode disposed on the banks.

The second electrode may be formed having a predetermined thickness of about 30 nm or less on entire exposed surfaces of the banks and the organic light emitting layers.

The auxiliary electrode may be formed having a predetermined thickness on an entire surface of the second electrode disposed on the banks, or may be formed in a stripe shape on the upper surface of the second electrode disposed between the pixels. The auxiliary electrode may have a thickness of about 10 nm or more. The auxiliary electrode may be formed of at least one metal selected from the group consisting of Al, Au, Pt, Ag, Yb, Cr, Mo, Ca, Ba and Mg.

The organic electroluminescent device may further comprise at least one passivation layer covering the second electrode and the auxiliary electrode. The passivation layers may comprise at least one organic passivation layer and at least one inorganic passivation layer, and in this case, the organic passivation layer and the inorganic passivation layer may be alternately stacked.

The substrate may be a glass substrate or a plastic substrate. The first electrodes may be formed corresponding to the pixels.

According to an aspect of the present invention, an exemplary embodiment of a method of manufacturing an organic electroluminescent device is provided, the method includes: forming a plurality of first electrodes on a substrate; forming banks which define pixels on the substrate; forming organic light emitting layers in the each of the pixels; forming a second electrode formed of a metal on upper surfaces of the banks and the organic light emitting layers; and forming an auxiliary electrode formed of a metal on an upper surface of the second electrode disposed on the banks.

The second electrode and the auxiliary electrode may be formed using a thermal evaporation method, a sputtering method or a printing method.

The method may further comprise forming at least one passivation layer covering the second electrode and the auxiliary electrode after the auxiliary electrode is formed.

### BRIEF DESCRIPTION OF THE DRAWINGS

The above and other aspects, features and advantages of the present invention will become more apparent by describing in further detail exemplary embodiments thereof with reference to the attached drawings, in which:

FIG. 1 is a cross-sectional view of a conventional top emission AM type organic electroluminescent device;

FIG. 2 is a plan view of an organic electroluminescent device according to an exemplary embodiment of the present invention;

FIG. 3 is a cross-sectional view taken along line III-III′ of FIG. 2;

FIG. 4 is a cross-sectional view of a modified version of an organic electroluminescent device according to another exemplary embodiment of the present invention;

FIG. 5 is a plan view of an organic electroluminescent device according to yet another exemplary embodiment of the present invention;

FIG. 6 is a cross-sectional view taken along line VI-VI′ of FIG. 5; and

FIGS. 7 through 10 are cross-sectional views for illustrating a method of manufacturing an organic electroluminescent device according to an exemplary embodiment of the present invention.

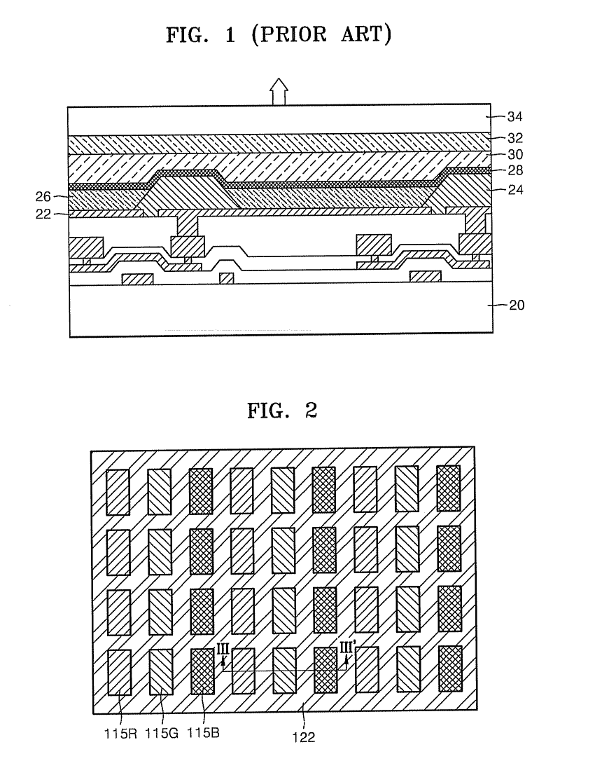

### DETAILED DESCRIPTION OF THE INVENTION

The invention now will be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including,” when used in this specification, specify the presence of stated features, regions, integers, steps, operations, elements and/or components, but do not preclude the presence or addition of one or more other features, regions, integers, steps, operations, elements, components and/or groups thereof.

Furthermore, relative terms, such as “lower” or “bottom” and “upper” or “top” may be used herein to describe one element's relationship to other elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on the “upper” side of the other elements. The exemplary term “lower” can, therefore, encompass both an orientation of “lower” and “upper,” depending upon the particular orientation of the figure. Similarly, if the device in one of the figures were turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning which is consistent with their meaning in the context of the relevant art and the present disclosure, and will not be interpreted in an idealized or overly formal sense unless expressly so defined herein.

Exemplary embodiments of the present invention are described herein with reference to cross section illustrations which are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes which result, for example, from manufacturing. For example, a region illustrated or described as flat may, typically, have rough and/or nonlinear features. Moreover, sharp angles which are illustrated may be rounded. Thus, the regions illustrated in the figures are schematic in nature and their shapes are not intended to illustrate the precise shape of a region and are not intended to limit the scope of the present invention.

Hereinafter, an apparatus for printing a biomolecular droplet on a substrate according to one exemplary embodiment of the present invention will be described in further detail with reference to the accompanying drawings.

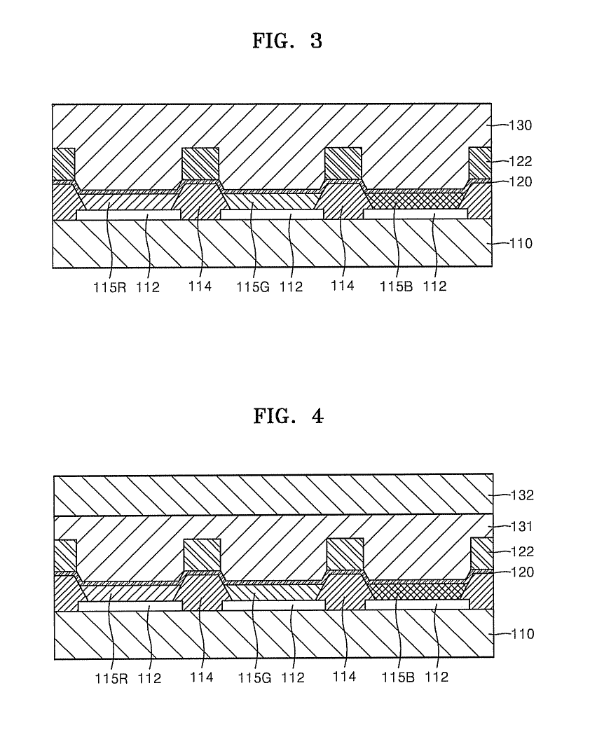

FIG. 2 is a plan view of a top emission AM type organic electroluminescent device according to an exemplary embodiment of the present invention. FIG. 3 is a cross-sectional view taken along line III-III′ of FIG. 2.

Referring to FIGS. 2 and 3, a plurality of first electrodes 112 are formed on a substrate 110. The substrate 110 can be a glass substrate or a plastic substrate, for example, but is not limited thereto. The first electrodes 112 are formed to correspond to pixels on the substrate 110. Although not depicted, a plurality of TFTs for driving the first electrodes 112 are formed below the first electrodes 112, as illustrated in FIG. 3. The first electrodes 112 can be anode electrodes. In a top emission type organic electroluminescent device, to increase luminous efficiency, visible light which proceeds toward the substrate 110 after being emitted from organic light emitting layers 115R, 115G and 115B, which will be described later, may be reflected by the first electrodes 112 so that the visible light can proceed upward. For this purpose, the first electrodes 112 can be formed to include a metal layer which reflects visible light.

Banks 114 which define pixels are formed to a predetermined thickness on the substrate 110 on which the first electrodes 112 are formed. Here, upper surfaces of the first electrodes 112 are exposed through the pixels defined by the banks 114. Organic light emitting layers which each emit a predetermined color, for example, the red light emitting layer 115R, the green light emitting layer 115G and the blue light emitting layer 115B, can be sequentially formed in each of the pixels. Unlike that depicted in the drawings, in the organic electroluminescent device according to an exemplary embodiment of the present invention, organic light emitting layers having the same color can be formed in the entire pixels to emit a mono-color, or an organic light emitting layer in which red, green and blue color light emitting materials are mixed can be formed in each of the pixels to emit white light.

A second electrode 120 is formed of a thin metal to a predetermined thickness on an upper surface of the banks 114 and the organic light emitting layers 115R, 115G and 115B. The second electrode 120 can be formed to cover entire exposed surfaces of each of the banks 114 and the organic light emitting layers 115R, 115G and 15B. Here, the second electrode 120 can be a cathode electrode. In a top emission type organic electroluminescent device according to the present invention, luminous efficiency can be increased as the light transmittance of the second electrode 120 increases. The second electrode 120 may be formed of a thin metal to increase the light transmittance of the second electrode 120. In the present exemplary embodiment, the second electrode 120 may be formed of at least one metal selected from the group consisting of Al, Au, Pt, Ag, Yb, Cr, Mo, Ca, Ba and Mg having a thickness of approximately 30 nm or less.

An auxiliary electrode 122 formed of a thick metal is formed on an upper surface of the second electrode 120. Here, the auxiliary electrode 122 is formed on an upper surface of the second electrode 120, except regions where the pixels are formed, as illustrated in FIG. 3. More specifically, as depicted in FIG. 2, the auxiliary electrode 122 can be formed on the entire surface of the second electrode 120 disposed on the banks 114. The auxiliary electrode 122 is formed to solve the problem of the second electrode 120 having reduced electrical conductivity, which can be caused by the thinness of the second electrode 120. That is, if only the thin second electrode 120 is formed on the banks 114 and the organic light emitting layers 115R, 115G and 115B without the auxiliary electrode 122, light transmittance can be increased, but electrical conductivity of the second electrode 120 is greatly reduced. Accordingly, in the present exemplary embodiment, not only light transmittance can be increased but also the electrical conductivity of the second electrode 120 can be increased by forming the auxiliary electrode 122 formed of a thick metal on the upper surface of the second electrode 120 except at regions where the pixels are formed. For this purpose, in the present exemplary embodiment, the auxiliary electrode 122 can be formed to a thickness of approximately 10 nm or more. The auxiliary electrode 122 can be formed of the same material as the second electrode 120, for example, at least one material selected from the group consisting of Al, Au, Pt, Ag, Yb, Cr, Mo, Ca, Ba and Mg.

In the present exemplary embodiment, a passivation layer 130 can further be formed on upper surfaces of the second electrode 120 and the auxiliary electrode 122. The passivation layer 130 is formed to protect devices formed therebelow, and can be formed of a transparent organic material or inorganic material.

As described above, in a top emission type organic electroluminescent device according to the present exemplary embodiment, the second electrode 120 is formed of a thin metal on upper surfaces of the banks 114 and the organic light emitting layers 115R, 115G and 115B, and the auxiliary electrode 122 having a thick metal is formed on the upper surface of the second electrode 120 except at regions where the pixels are formed. Accordingly, since only the second electrode 120 made of a thin metal is formed on the pixels, the light transmittance is increased. Also, the auxiliary electrode 122 made of a thick metal is formed on the upper surface of the second electrode 120 except at regions where the pixels are formed, therefore, the problem of reduced electrical conductivity of the second electrode 120 is solved. In the above described exemplary embodiment, the first electrodes 112 are anode electrodes, and the second electrode 120 is a cathode electrode. However, in the present invention, the first electrodes 112 can be cathode electrodes, and the second electrode 120 can be an anode electrode in alternative exemplary embodiments.

FIG. 4 is a cross-sectional view of a modified version of an organic electroluminescent device according to another exemplary embodiment of the present invention. Hereinafter, the main differences from the previous embodiment of FIGS. 2 and 3 will be described. Referring to FIG. 4, a plurality of passivation layers 131 and 132 are stacked on a second electrode 120 and an auxiliary electrode 122, instead of the passivation layer 130 of FIG. 3. In FIG. 4, there are two passivation layers 131 and 132 formed, but the present invention is not limited thereto. That is, three or more passivation layers can be formed in alternative exemplary embodiments. The passivation layers 131 and 132 can include at least one inorganic passivation layer and at least one organic passivation layer. In this case, the inorganic passivation layer and the organic passivation layer can be alternately stacked.

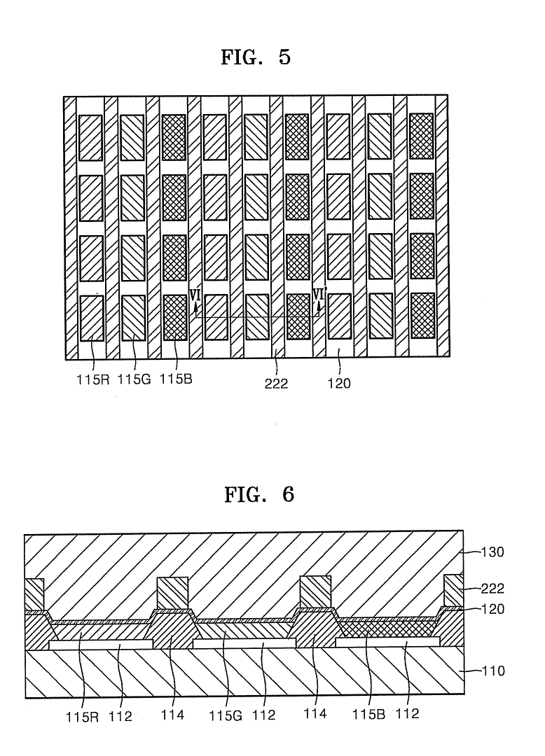

FIG. 5 is a plan view of a top emission type organic electroluminescent device according to yet another exemplary embodiment of the present invention. FIG. 6 is a cross-sectional view taken along line VI-VI′ of FIG. 5. Hereinafter, the main differences from the previous exemplary embodiments of FIGS. 2-4 will be described.

Referring to FIGS. 5 and 6, a plurality of first electrodes 112 are formed on a substrate 110. Banks 114 which define pixels are formed to a predetermined thickness on the substrate 110 where the first electrodes 112 are formed. Organic light emitting layers 115R, 115G and 115B, each having a predetermined color, are sequentially formed in the pixels. In the present exemplary embodiment, as described above, the same color organic light emitting layers can be formed in the entire pixels, or an organic light emitting layer in which red, green and blue color light emitting materials are mixed can be formed in each of the pixels.

A second electrode 120 made of a thin metal is formed to a predetermined thickness on upper surfaces of the banks 114 and the organic light emitting layers 115R, 115G and 115B. The second electrode 120 can be formed having a thickness of approximately 30 nm or less. The second electrode 120 can be formed of at least one metal selected from the group consisting of, for example, Al, Au, Pt, Ag, Yb, Cr, Mo, Ca, Ba and Mg.

Auxiliary electrodes 222 made of a thick metal are formed on an upper surface of the second electrode 120. Here, the auxiliary electrodes 222 are formed in a stripe shape on the upper surface of the second electrode 120 disposed between the pixels. In FIG. 5, the stripe shaped auxiliary electrodes 222 are formed parallel to the pixels in which organic light emitting layers 115R, 115G and 115B having the same color are formed, however, the present invention is not limited thereto. That is, the auxiliary electrodes 222 can be formed in a stripe shape crossing the pixels in which organic light emitting layers 115R, 115G and 115B having the same color are formed. In the present invention, the auxiliary electrodes 222 can be formed in various shapes other than the stripe shape illustrated in FIGS. 5 and 6. As described in the previous exemplary embodiments, the purpose of the auxiliary electrodes 222 is to solve the problem of reduced electrical conductivity of the second electrode 120, which can be caused by the thin second electrode 120. The auxiliary electrodes 222 can be formed of the same material as the second electrode 120 having a thickness of approximately 10 nm or more.

A passivation layer 130 can be formed on upper surfaces of the second electrode 120 and the auxiliary electrodes 222. In FIG. 6, one passivation layer 130 is formed on the second electrode 120 and the auxiliary electrodes 222, however, the present invention is not limited thereto. That is, a plurality of passivation layers can be formed on the second electrode 120 and the auxiliary electrodes 222, as in the exemplary embodiment of FIG. 4. At this time, the passivation layers can include at least one organic passivation layer and at least one inorganic passivation layer.

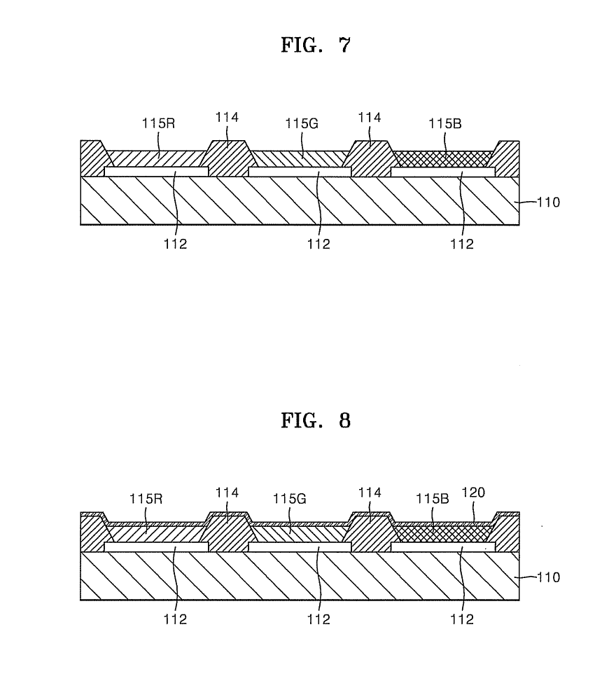

Hereinafter, a method of manufacturing a top emission type organic electroluminescent device will now be described with reference to FIGS. 7 through 10. FIGS. 7 through 10 are cross-sectional views illustrating a method of manufacturing an organic electroluminescent device according to an exemplary embodiment of the present invention.

Referring to FIG. 7, a plurality of first electrodes 112 are formed on a substrate 110. The substrate 110 can be a glass substrate or a plastic substrate, for example, but is not limited thereto. The first electrodes 112 can be formed having a predetermined shape corresponding to pixels. The first electrodes 112 can be formed by patterning a predetermined conductive material after the conductive material is deposited on the substrate 110. In the present exemplary embodiment, the first electrodes 112 include a metal layer which reflects visible light. Next, banks 114 which define the pixels are formed having a predetermined thickness on the substrate 110 on which the first electrodes 112 are formed. The banks 114 can be formed by patterning a predetermined material after the predetermined material is coated on the substrate 110 on which the first electrodes 112 are formed. Accordingly, upper surfaces of the first electrodes 112 are exposed through the pixels defined by the banks 114. Next, organic light emitting layers each having a predetermined color, for example, a red light emitting layer 115R, a green light emitting layer 115G and a blue light emitting layer 115B, are formed in the pixels. In the present exemplary embodiment, as described above, organic light emitting layers having a single color can be formed in each of the pixels to emit a respective mono-color, or an organic light emitting layer in which red, green and blue color light emitting materials are mixed can be formed in each of the pixels to emit white light.

Referring to FIG. 8, a second electrode 120 formed of a thin metal is formed on upper surfaces of the banks 114 and the organic light emitting layers 115R, 115G and 115B. The second electrode 120 can be formed having a thickness of approximately 30 nm or less to secure a predetermined light transmittance. The second electrode 120 can be formed to cover the entire exposed surfaces of the banks 114 and the organic light emitting layers 115R, 115G and 115B using a thermal evaporation method, a sputtering method or a printing method. The second electrode 120 can be formed of at least one metal selected from the group consisting of Al, Au, Pt, Ag, Yb, Cr, Mo, Ca, Ba and Mg.

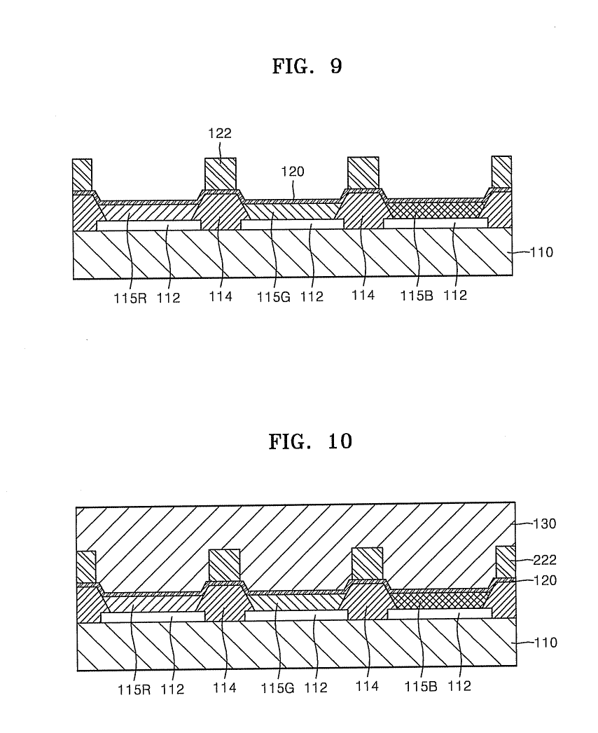

Referring to FIG. 9, an auxiliary electrode 122 formed of a thick metal is formed on an upper surface of the second electrode 120 except at regions where the pixels are formed. The auxiliary electrode 122 is formed to solve the problem of reduced electrical conductivity of the second electrode 120, which can be caused by the second electrode 120 being thin, and can be formed to a thickness of approximately 10 nm or more. The auxiliary electrode 122 and the second electrode 120 can be formed of the same material, for example, being formed of at least one metal selected from the group consisting of Al, Au, Pt, Ag, Yb, Cr, Mo, Ca, Ba and Mg.

The auxiliary electrode 122 can be formed having a predetermined thickness on the entire surface of the second electrode 120 disposed on the banks 114. Also, the auxiliary electrode 122 can be formed in a stripe shape on the upper surface of the second electrode 120 disposed between the pixels (e.g., see FIG. 5), or can be formed in various shapes. The auxiliary electrode 122, like the second electrode 120, can be formed in a predetermined shape using a thermal evaporation method, a sputtering method or a printing method. When the auxiliary electrode 122 is formed using a thermal evaporation method or a sputtering method, a mask in which a pattern exposes a predetermined region of the second electrode 120 can be used.

Referring to FIG. 10, after the auxiliary electrode 122 is formed, an operation for forming a passivation layer 130 of a transparent material on upper surfaces of the second electrode 120 and the auxiliary electrode 122 can further be included. In FIG. 10, one passivation layer 130 is formed, however as described above, the present invention is not limited thereto. That is, a plurality of passivation layers can be formed on the second electrode 120 and the auxiliary electrode 122 (e.g., see FIG. 4). Also, the passivation layers can include at least one organic passivation layer and one inorganic passivation layer, and at this time, the organic passivation layer and the inorganic passivation layer can be alternately stacked.

As described above, according to the present invention, light transmittance of an organic electroluminescent device can be increased by forming only an electrode of a thin metal on pixels, and electrical conductivity can be increased by forming an auxiliary electrode of a thick metal on an upper surface of the electrode except at regions corresponding to where the pixels are formed. Also, since only an electrode made of a metal is formed on the organic light emitting layers, the possibility of damage to the organic light emitting layers, which can occur when a transparent conductive material, such as ITO, is formed on the organic light emitting layers in a conventional organic electroluminescent device, can be avoided.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An organic electroluminescent device comprising:
a substrate;
a plurality of first electrodes formed on the substrate;
a plurality of banks formed on the substrate to define pixels on the first electrodes;
a plurality of organic light emitting layers filled in the pixels;
a second electrode formed of a metal on upper surfaces of the banks and the organic light emitting layers; and
an auxiliary electrode formed of a metal in a predetermined shape on an upper surface of the second electrode disposed on the banks.

2. The organic electroluminescent device of claim 1, wherein the second electrode is formed having a predetermined thickness on entire exposed surfaces of the banks and the organic light emitting layers.

3. The organic electroluminescent device of claim 1, wherein the second electrode has a thickness of about 30 nm or less.

4. The organic electroluminescent device of claim 2, wherein the second electrode is formed of at least one metal selected from the group consisting of Al, Au, Pt, Ag, Yb, Cr, Mo, Ca, Ba and Mg.

5. The organic electroluminescent device of claim 1, wherein the auxiliary electrode is formed having a predetermined thickness on an entire exposed surface of the second electrode disposed on the banks.

6. The organic electroluminescent device of claim 1, wherein the auxiliary electrode is formed in a stripe shape on the upper surface of the second electrode disposed between the pixels.

7. The organic electroluminescent device of claim 1, wherein the auxiliary electrode has a thickness of about 10 nm or more.

8. The organic electroluminescent device of claim 1, wherein the auxiliary electrode is formed of at least one metal selected from the group consisting of Al, Au, Pt, Ag, Yb, Cr, Mo, Ca, Ba and Mg.

9. The organic electroluminescent device of claim 1, further comprising at least one passivation layer covering the second electrode and the auxiliary electrode.

10. The organic electroluminescent device of claim 9, wherein the passivation layers comprise at least one organic passivation layer and at least one inorganic passivation layer

11. The organic electroluminescent device of claim 10, wherein the organic passivation layer and the inorganic passivation layer are alternately stacked.

12. The organic electroluminescent device of claim 1, wherein the substrate is a glass substrate or a plastic substrate.

13. The organic electroluminescent device of claim 1, wherein the first electrodes are formed corresponding to respective pixels.

14. The organic electroluminescent device of claim 13, wherein the first electrodes comprise a metal layer which reflects visible light emitted from the organic light emitting layers.

15. A method of manufacturing an organic electroluminescent device, the method comprising:
forming a plurality of first electrodes on a substrate;
forming banks which define pixels on the substrate;
forming organic light emitting layers in the each of the pixels;
forming a second electrode of a metal on upper surfaces of the banks and the organic light emitting layers; and
forming an auxiliary electrode of a metal on an upper surface of the second electrode disposed on the banks.

16. The method of claim 15, wherein the second electrode is formed having a predetermined thickness on entire exposed surfaces of the banks and the organic light emitting layers.

17. The method of claim 16, wherein the second electrode has a thickness of about 30 nm or less.

18. The method of claim 16, wherein the second electrode is formed of at least one metal selected from the group consisting of Al, Au, Pt, Ag, Yb, Cr, Mo, Ca, Ba and Mg.

19. The method of claim 15, wherein the auxiliary electrode is formed having a predetermined thickness on an entire surface of the second electrode disposed on the banks.

20. The method of claim 15, wherein the auxiliary electrode is formed in a stripe shape on the upper surface of the second electrode disposed between the pixels.

21. The method of claim 15, wherein the auxiliary electrode has a thickness of about 10 nm or more.

22. The method of claim 15, wherein the auxiliary electrode is formed of at least one metal selected from the group consisting of Al, Au, Pt, Ag, Yb, Cr, Mo, Ca, Ba and Mg.

23. The method of claim 15, wherein the second electrode and the auxiliary electrode are formed using a thermal evaporation method, a sputtering method or a printing method.

24. The method of claim 15, further comprising forming at least one passivation layer covering the second electrode and the auxiliary electrode after the auxiliary electrode is formed.

25. The method of claim 24, wherein the at least one passivation layer comprises at least one organic passivation layer and at least one inorganic passivation layer.

26. The method of claim 25, wherein the organic passivation layer and the inorganic passivation layer are alternately stacked.
